(19) United States
(12) Patent Application Publication
(10) Pub. No.: US 2026/0008110 A1
(43) Pub. Date: Jan. 8, 2026

(54) WORK MACHINE CONTROL DEVICE AND A NON-TRANSITORY COMPUTER-READABLE STORAGE MEDIUM

(71) Applicant: FANUC CORPORATION, Yamanashi (JP)

(72) Inventor: Yuuki KUMAMOTO, Yamanashi (JP)

(73) Assignee: FANUC CORPORATION, Yamanashi (JP)

(21) Appl. No.: 18/993,167

(22) PCT Filed: Sep. 7, 2022
(86) PCT No.: PCT/JP2022/033611

§ 371 Date: Jan. 10, 2025

(51) Int. Cl. B23B 29/12; B23B 25/02; G05B 19/404; G05B 19/4093

(52) U.S. Cl. CPC B23B 29/125; B23B 25/02; G05B 19/404; G05B 19/4093; G05B 2219/49055; G05B 2219/49277

(57) ABSTRACT

The purpose of the present invention is to both break down chips and suppress sympathetic vibration in a machine. This work machine control device superposes a swinging command for commanding relative swinging between a workpiece and a cutting tool onto a movement command for commanding relative movement between the workpiece and the cutting tool, thereby generating air cuts in chips from the workpiece to break down the chips. A position information acquisition unit of the work machine control device acquires position information related to the relative positions of the workpiece and the tool. A state assessment unit of the work machine control device assesses that a state of instability is in effect, under the condition that a positional deviation exceeds a threshold value, the positional deviation increasing with increases in the difference between actual relative positions that are based on the position information and command relative positions that are based on the movement command and the swinging command. A swinging switching unit of the work machine control device performs a switching process for switching a swinging condition in relative swinging, under the condition that it is assessed that the state of instability is in effect.

### TECHNICAL FIELD

The present invention relates to a machine tool control device that controls a machine tool.

### BACKGROUND ART

Among machine tool control devices, some devices superimpose an oscillation command, which instructs relative oscillation between a workpiece and a cutting tool, onto a movement command, which instructs relative movement between the workpiece and the cutting tool, in order to generate air cuts during the cutting of the workpiece with the cutting tool, thereby breaking up the chips.

### CITATION LIST

### Patent Document

Patent Document 1: Japanese Unexamined Patent Application, Publication No. 2020-144588

### DISCLOSURE OF THE INVENTION

### Problems to be Solved by the Invention

With such a machine tool control device, the relative oscillation breaking up the chips into smaller pieces, allowing for suppression of issues such as chips becoming entangled with the cutting tool. However, the present inventors have focused on the potential for the following problems to occur.

That is, depending on the oscillation conditions, there is a risk that the frequency of the relative oscillation may match the resonant frequency of the machine tool, thereby inducing mechanical resonance. As a result, this risk may lead to defects in the processing of the workpiece, stoppage of the machine tool, or damage to the cutting tool. On the other hand, it is difficult to ensure in advance that mechanical resonance will not occur, because it requires comprehensive checking of each machining condition since the oscillation conditions may vary depending on the machining conditions.

In light of such circumstances, an object of the present disclosure aims to achieve both breaking up of chips and suppression of mechanical resonance.

### Means for Solving the Problems

A machine tool control device of the present disclosure controls a machine tool including a cutting tool for cutting a workpiece, and superimposes an oscillation command instructing relative oscillation between the workpiece and the cutting tool onto a movement command instructing relative movement between the workpiece and the cutting tool, thereby generating air cuts to break up the chips while cutting the workpiece, in which the machine tool control device includes:
a position information acquisition unit that acquires position information on a relative position between the workpiece and the cutting tool;
a state determination unit that determines an unstable state, on condition that a position deviation exceeds a threshold value, wherein the position deviation increases as a difference between an actual relative position as the relative position based on the position information and a command relative position as the relative position based on the movement command and the oscillation command increases; and
an oscillation switching unit that executes switching processing for changing an oscillation condition of the relative oscillation, on condition that the unstable state has been determined.

A machine tool control program of the present disclosure causes a computer to function as a machine tool control device that controls a machine tool including a cutting tool for cutting a workpiece, and superimposes an oscillation command instructing relative oscillation between the workpiece and the cutting tool onto a movement command instructing relative movement between the workpiece and the cutting tool, thereby generating air cuts to break up the chips while cutting the workpiece, in which
the machine tool control program further causes the computer to function as units including:
a position information acquisition unit that acquires position information on a relative position between the workpiece and the cutting tool;
a state determination unit that determines an unstable state, on condition that a position deviation exceeds a threshold value, wherein the position deviation increases as a difference between an actual relative position as the relative position based on the position information and a command relative position as the relative position based on the movement command and the oscillation command increases; and
an oscillation switching unit that executes switching processing for changing an oscillation condition of the relative oscillation, on condition that the unstable state has been determined.

### Effects of the Invention

The present disclosure can achieve both breaking up of the chips and suppression of mechanical resonance.

### BRIEF DESCRIPTION OF THE DRAWINGS

FIG. 1 is a configuration diagram illustrating the machine tool control device and the machine tool of the first embodiment;

FIG. 2 is a configuration diagram illustrating the machine tool control device;

FIG. 3 is a graph illustrating the transition of the actual relative position and the position deviation;

FIG. 4 is a configuration diagram illustrating the machine tool control device of the second embodiment;

FIG. 5 is a graph illustrating the transition of the position deviation; and

FIG. 6 is a configuration diagram illustrating the machine tool control device of the third embodiment.

### PREFERRED MODE FOR CARRYING OUT THE INVENTION

Hereinafter, embodiments of the present disclosure will be described with reference to the drawings. However, the present disclosure is not limited to the following embodiments and can be implemented with appropriate modifications without departing from the spirit of the present disclosure.

### First Embodiment

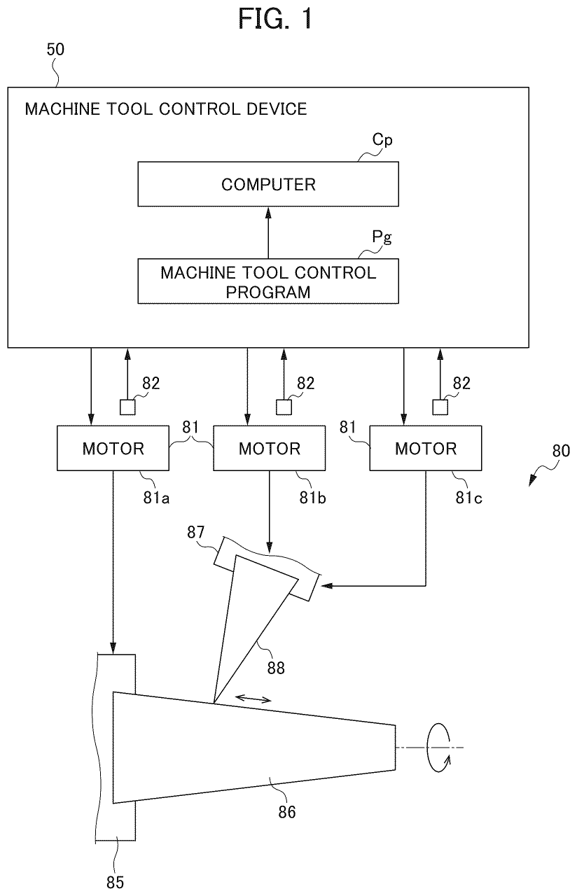

As illustrated in FIG. 1, the machine tool 80 includes a workpiece holding unit 85 that holds the workpiece 86, and a tool holding unit 87 that holds the cutting tool 88. For example, the workpiece holding unit 85 is driven by a first motor 81a as a spindle motor, while the tool holding unit 87 is driven by a second motor 81b and a third motor 81c. Hereinafter, the first motor 81a, the second motor 81b, and the third motor 81c are collectively referred to as “motor 81”.

The relative movement between the workpiece holding unit 85 and the tool holding unit 87 results in relative movement between the workpiece 86 and the cutting tool 88. Hereinafter, the relative movement between the cutting tool 88 and the workpiece 86 for cutting the workpiece 86 will simply be referred to as “relative movement”, and the relative position between the cutting tool 88 and the workpiece 86 will simply be referred to as “relative position”. The relative oscillation between the cutting tool 88 and the workpiece 86 in a direction intersecting the direction of relative movement will simply be referred to as “relative oscillation”.

Each motor 81 includes an encoder 82 that detects the rotation angle of the motor 81. Hereinafter, the relative position based on the rotation angle detected by the encoders 82 will be referred to as the “actual relative position Pa”.

The machine tool control device 50 controls the machine tool 80 as described above. The machine tool control device 50 is mainly configured by, for example, a numerical control device and a servo control device that operates the motor 81 and the like based on commands from the numerical control device. From another perspective, the machine tool control device 50 is mainly configured by a computer Cp and a machine tool control program Pg that causes the computer Cp to function as the machine tool control device 50. The computer Cp herein encompasses a numerical control device, a servo control device, and the like, and includes a calculation unit, a display, an operation unit, etc. The calculation unit of the computer Cp includes, for example, a CPU, RAM, ROM, etc.

The machine tool control device 50 presses the cutting tool 88 against the workpiece 86 through relative movement by control of the machine tool 80, and through further relative movement, cuts the workpiece 86 with the cutting tool 88. Furthermore, the machine tool control device 50 intermittently generates air cuts, where the cutting tool 88 does not cut the workpiece 86, by superimposing the relative oscillation onto the relative movement during the cutting of the workpiece 86, thereby breaking up the chips.

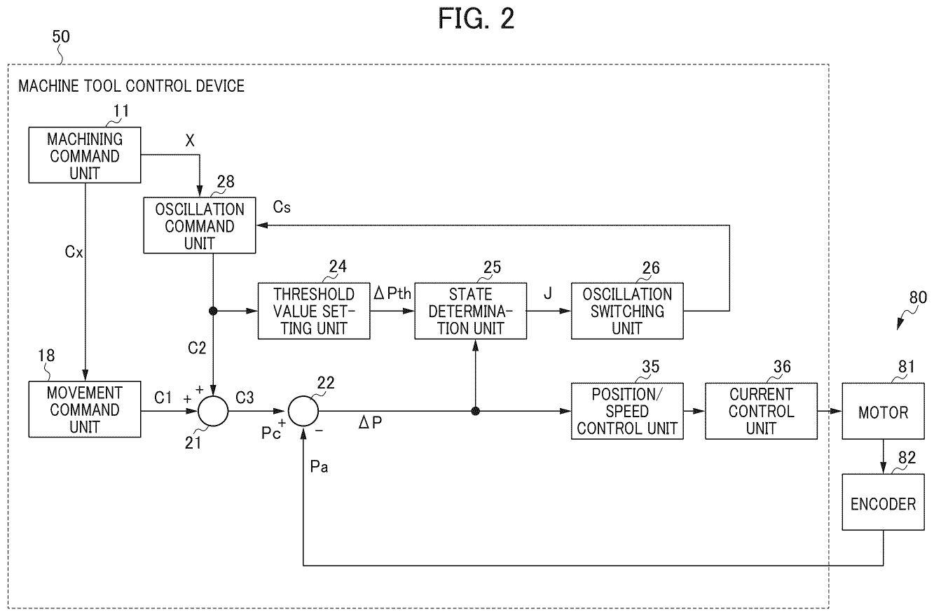

As illustrated in FIG. 2, the machine tool control device 50 includes a machining command unit 11, a movement command unit 18, an oscillation command unit 28, an adder 21, a subtractor 22, a position/speed control unit 35, and a current control unit 36. The subtractor 22 may be referred to as the “position information acquisition unit”.

The machining command unit 11 is configured to allow a machining program to be input by the user who, for example, operates the operation unit while checking the display of a numerical control device or the like.

The movement command unit 18 calculates a “movement command C1” as a command value for relative movement, based on the machining command Cx derived from the machining program. The oscillation command unit 28 calculates an “oscillation command C2” as a command value for relative oscillation, based on the machining conditions X derived from the machining program. Specifically, the oscillation command unit 28 calculates a repetitive sinusoidal command as the oscillation command C2.

The adder 21 acquires the movement command C1 from the movement command unit 18 and acquires the oscillation command C2 from the oscillation command unit 28. Then, by adding the oscillation command C2 to the movement command C1, the adder 21 calculates a superimposed command C3. Hereinafter, the relative position when the relative movement has been executed accurately in accordance with the superimposed command C3 will be referred to as the “command relative position Pc”.

The subtractor 22 acquires the command relative position Pc from the adder 21 and acquires the actual relative position Pa from the encoder 82. Then, by subtracting the actual relative position Pa from the command relative position Pc, the subtractor 22 calculates the position deviation ΔP.

The position/speed control unit 35 acquires the position deviation ΔP from the subtractor 22. The position/speed control unit 35 generates a torque command for the motor 81, based on the position deviation ΔP or an integral value thereof. In other words, the position/speed control unit 35 executes feedback control in collaboration with the subtractor 22.

The current control unit 36 calculates a current value based on the torque command received from the position/speed control unit 35, and operates the motor 81 based on the calculated current value. This allows the cutting tool 88 to cut the workpiece 86 while executing air cuts to break up the chips.

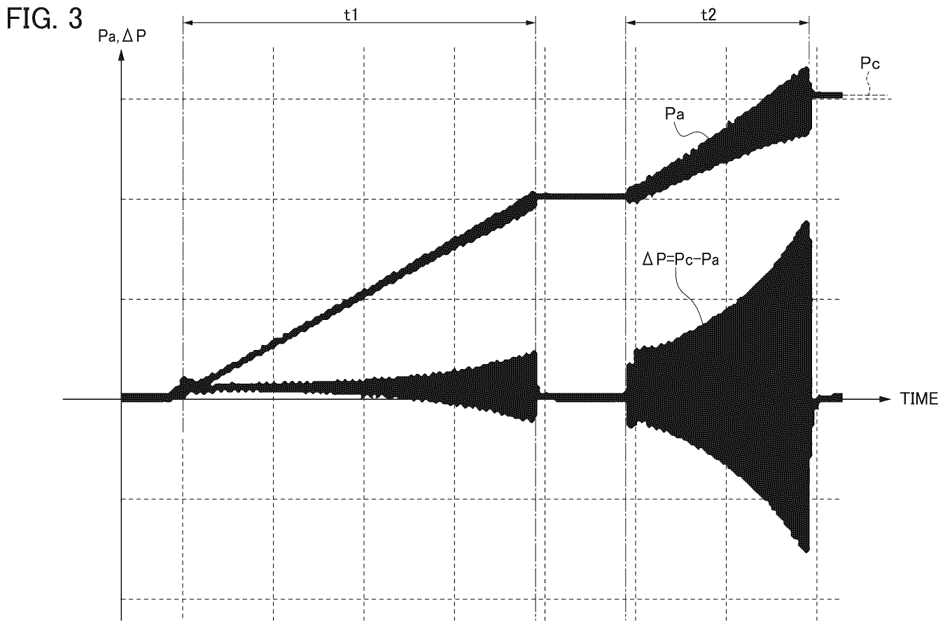

Next, with reference to FIG. 3, the problem to be solved by the present embodiment will be described. The upper curve in FIG. 3 indicates an example of the transition of the actual relative position Pa. In other words, the upper curve is painted black because they are closely spaced in the lateral direction, but indicates a wave-like path that includes relative oscillation. The broken line overlapping the curve showing the actual relative position Pa indicates the command relative position Pc. The amplitude of the command relative position Pc is smaller than the amplitude of the actual relative position Pa in most of the terms t1 and t2, which will be described later. The lower curve indicates the transition of the position deviation ΔP. The position deviation ΔP is also painted black because they are closely spaced in the lateral direction, but indicates a wave-like path with a cycle almost the same to that of the actual relative position Pa. In FIG. 3, the position deviation ΔP is illustrated with an enlarged vertical scale. Therefore, the length of “ΔP” in the vertical axis in FIG. 3 is longer than the length of difference between the “Pc” and “Pa” in the vertical axis.

Hereinafter, the term during which relative movement and relative oscillation are executed in a predetermined manner is referred to as “first term t1”, and the term during which relative movement and relative oscillation are executed in a different manner is referred to as “second term t2”. During the first term t1, mechanical resonance does not occur significantly, thus the position deviation ΔP remains relatively small. In contrast, during the second term t2, mechanical resonance occurs more significantly, thus the position deviation ΔP is larger than that in the first term t1. This may lead to defects in the machining of the workpiece 86, stoppage of the machine tool 80, or damage to the cutting tool 88.

In order to solve these issues, as illustrated in FIG. 2, the machine tool control device 50 further includes a threshold value setting unit 24, a state determination unit 25, and an oscillation switching unit 26.

The threshold value setting unit 24 acquires the oscillation command C2 from the oscillation command unit 28, calculates the “command amplitude” as the amplitude of the command relative position Pc, and sets a value greater than this command amplitude as the threshold value ΔPth for the position deviation ΔP. Specifically, as the command amplitude increases, the threshold value setting unit 24 sets the threshold value ΔPth to a larger value. More specifically, for example, the threshold value setting unit 24 sets the threshold value ΔPth to a value obtained by multiplying the command amplitude by a predetermined value, or by further adding or subtracting a predetermined value to/from the value obtained. Alternatively, as the command amplitude increases, the threshold value ΔPth may be set to increase stepwise. In other words, the threshold value ΔPth may not only be calculated by multiplying the command amplitude by a fixed value but may also vary the predetermined value to be multiplied depending on the magnitude of the command amplitude. The threshold value setting unit 24 transmits the set threshold value ΔPth to the state determination unit 25.

The state determination unit 25 acquires the position deviation ΔP from the subtractor 22 and acquires the threshold value ΔPth from the threshold value setting unit 24. The state determination unit 25 determines a stable state in a case where the position deviation ΔP is less than or equal to the threshold value ΔPth, and determines an unstable state in a case where the position deviation ΔP exceeds the threshold value ΔPth. In other words, the state determination unit 25 determines an unstable state, on condition that the position deviation ΔP exceeds the threshold value ΔPth. The state determination unit 25 transmits the determination result J to the oscillation switching unit 26.

The oscillation switching unit 26, upon receiving the determination result J indicating an unstable state, transmits a switching command Cs to the oscillation command unit 28. The processing for transmitting the switching command Cs corresponds to the “switching processing” for switching the oscillation conditions.

Hereinafter, the vibration frequency of the command relative position Pc is referred to as the “command frequency”. The oscillation switching unit 26 transmits at least one of a command to change the command frequency or a command to reduce the command amplitude, as the switching command Cs, to the oscillation command unit 28. The oscillation command unit 28 switches the oscillation conditions of the relative oscillation, based on this switching command Cs.

In a case where the stable state is not achieved even after the switching, the state determination unit 25 will again determine an unstable state, and the oscillation switching unit 26 will issue another switching command Cs to switch the oscillation conditions again. This switching of oscillation conditions will be repeated until the stable state is achieved, that is, until the amplitude of the position deviation ΔP falls below the threshold value ΔPth. Eventually, a stable state will be achieved.

The following is a summary of the configuration and effects of the present embodiment.

The adder 21 creates a superimposed command C3 by superimposing the oscillation command C2 onto the movement command C1. Based on this superimposed command C3, the position/speed control unit 35 and the current control unit 36 control the motor 81, thereby executing the cutting of the workpiece 86 and generating air cuts. This allows the workpiece 86 to be cut while breaking up the generated chips, thereby suppressing issues such as chips becoming entangled with the cutting tool 88.

The subtractor 22 acquires the command relative position Pc from the adder 21 and the actual relative position Pa from the encoder 82, and calculates the position deviation ΔP. The state determination unit 25 determines an unstable state, on condition that the position deviation ΔP exceeds the threshold value ΔPth. The oscillation switching unit 26, upon an unstable state determined, switches the oscillation conditions of the relative oscillation. This allows the suppression of mechanical resonance by avoiding the unstable state.

As described above, the present embodiment can achieve both breaking up of the chips and suppression of mechanical resonance. More specifically, the following effects can be achieved:

The oscillation switching unit 26, upon determining an unstable state, executes at least one of the processing for changing the command frequency or the processing for reducing the command amplitude, as the switching processing. In a case of changing the command frequency, the frequency of the relative oscillation is shifted away from the resonant frequency of the machine tool 80, thereby allowing for avoiding mechanical resonance. In a case of reducing the command amplitude, the amplitude of the relative oscillation is suppressed, thereby allowing for reducing mechanical resonance. Therefore, mechanical resonance can be suppressed by these processing.

The threshold value setting unit 24 calculates the threshold value ΔPth, based on the magnitude of the command amplitude. Specifically, the threshold value setting unit 24 can set an appropriate threshold value ΔPth by setting the threshold value ΔPth to a value larger than the command amplitude calculated by the oscillation command unit 28 each time.

### Second Embodiment

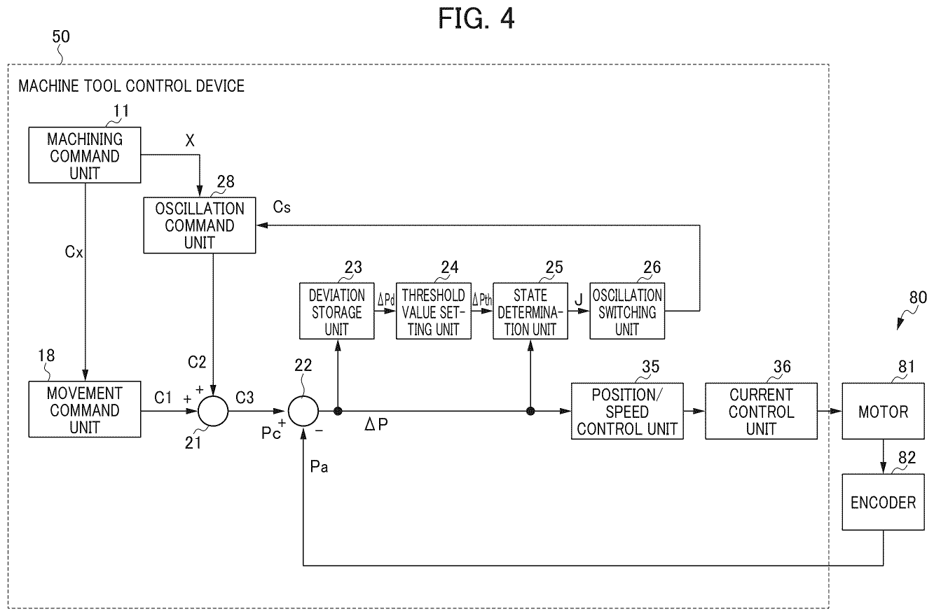

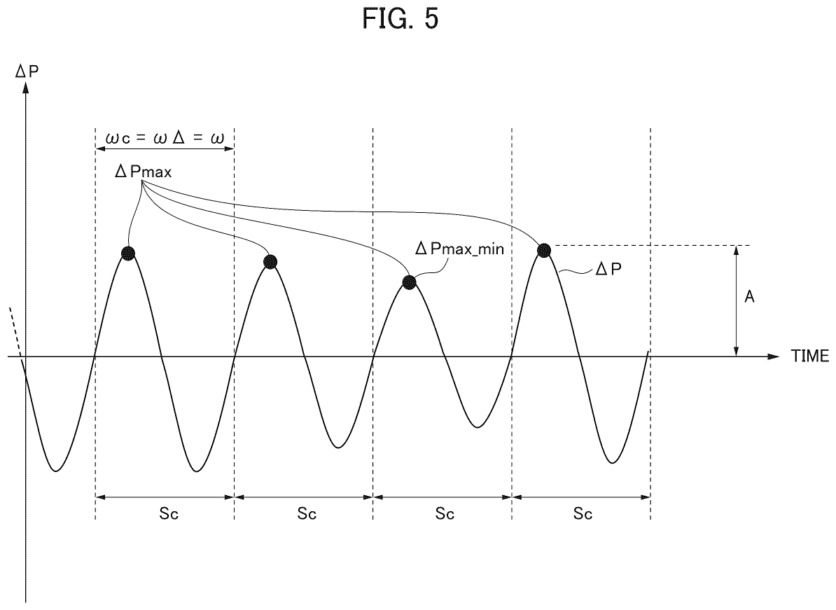

Next, the second embodiment will be described with reference to FIGS. 4 and 5. The present embodiment is described with a focus on the differences from the first embodiment, and the same or similar aspects to the first embodiment will be omitted as appropriate.

As illustrated in FIG. 4, the machine tool control device 50 of the present embodiment further includes a deviation storage unit 23. The deviation storage unit 23 acquires and stores the position deviation ΔP from the subtractor 22. The threshold value setting unit 24 calculates the threshold value ΔPth, based on the history ΔPd of the position deviation stored in the deviation storage unit 23. This is specifically described as follows.

As illustrated in FIG. 5, the oscillation cycle of the position deviation ΔP is referred to as the “deviation oscillation cycle ωΔ”, and the oscillation cycle of the command relative position Pc is referred to as the “command oscillation cycle ωc”. As described above, the adder 21 superimposes a repetitive sinusoidal command as the oscillation command C2 onto the movement command C1. Therefore, the position deviation ΔP contains disturbances, such as cutting disturbances, and also contains many frequency components that are the same as the aforementioned sinusoidal command. In other words, the command oscillation cycle ωc and the deviation oscillation cycle ωΔ become substantially equal. Hereinafter, the command oscillation cycle ωc and the deviation oscillation cycle ωΔ will be collectively referred to as the “oscillation cycle ω”. Furthermore, the interval divided based on the oscillation cycle ω is referred to as the “divided section Sc”, and the maximum value of the position deviation ΔP within the divided section Sc is referred to as the “sectional maximum deviation ΔPmax”. However, instead of the maximum value of the position deviation ΔP, the maximum absolute value of the position deviation ΔP may be referred to as the “sectional maximum deviation ΔPmax”.

The threshold value setting unit 24 calculates the sectional maximum deviation ΔPmax for each divided section Sc. Specifically, in the present embodiment, the length of each divided section Sc is an integral multiple of half the length of the oscillation cycle ω. Therefore, the maximum value of the position deviation ΔP in each divided section Sc becomes the sectional maximum deviation ΔPmax in that divided section Sc. The state in which the sectional maximum deviation ΔPmax reaches the minimum value ΔPmax_min can be regarded as a steady state of the position deviation ΔP, that is, a stable state.

The threshold value setting unit 24 sets the threshold value ΔPth to a value obtained by multiplying the minimum value ΔPmax_min of the sectional maximum deviation by a predetermined multiplying factor greater than 1. Alternatively, the threshold value ΔPth may be set to a value obtained by multiplying the average value of the sectional maximum deviation ΔPmax within a plurality of predetermined divided sections Sc by a predetermined multiplying factor greater than 1.

The threshold value setting unit 24 transmits the set threshold value ΔPth to the state determination unit 25, as illustrated in FIG. 4. The subsequent steps are the same as those in the first embodiment. Therefore, the state determination unit 25 determines a state, based on the received threshold value ΔPth.

The following is a summary of the configuration and effects of the present embodiment.

The deviation storage unit 23 stores the position deviation ΔP. The threshold value setting unit 24 calculates the threshold value ΔPth, based on the history ΔPd of the position deviation ΔP stored in the deviation storage unit 23. Therefore, instead of setting the threshold value ΔPth simply based on the command amplitude, the threshold value ΔPth can be set based on the history of the position deviation ΔP. As a result, more appropriate threshold value ΔPth settings can be expected.

The threshold value setting unit 24 calculates the sectional maximum deviation ΔPmax for each divided section Sc. The sectional maximum deviation ΔPmax is sequentially calculated, the calculated sectional maximum deviation ΔPmax is then compared with the stored sectional maximum deviation ΔPmax, and the smaller of the two is continuously updated as the minimum value ΔPmax_min. This minimum value ΔPmax_min can be regarded as the steady state of the position deviation ΔP, that is, a stable state. Since the threshold value ΔPth is determined based on this minimum value ΔPmax_min, more appropriate threshold value ΔPth settings can be expected.

The adder 21 superimposes a repetitive sinusoidal command as the oscillation command C2 onto the movement command C1. As a result, the position deviation ΔP also contains many frequency components that are the same as those of this sinusoidal command. Focusing on this characteristic, the cycle of the divided section Sc is set to be an integral multiple of half the cycle of the command oscillation cycle ωc. By setting the threshold value ΔPth by setting the maximum deviation in this divided section Sc as the sectional maximum deviation ΔPmax, more appropriate threshold value ΔPth settings can be achieved.

The threshold value setting unit 24 sets the threshold value ΔPth to a value obtained by multiplying the minimum value ΔPmax_min of the sectional maximum deviation, or the average value of the sectional maximum deviation ΔPmax within a plurality of divided sections Sc, by a predetermined multiplying factor greater than 1. This provides a margin between the minimum value ΔPmax_min and the threshold value ΔPth, or between the average value and the threshold value ΔPth. This can suppress the adverse effects of determining an unstable state each time the position deviation ΔP exceeds the threshold value ΔPth due to disturbances or the like.

### Third Embodiment

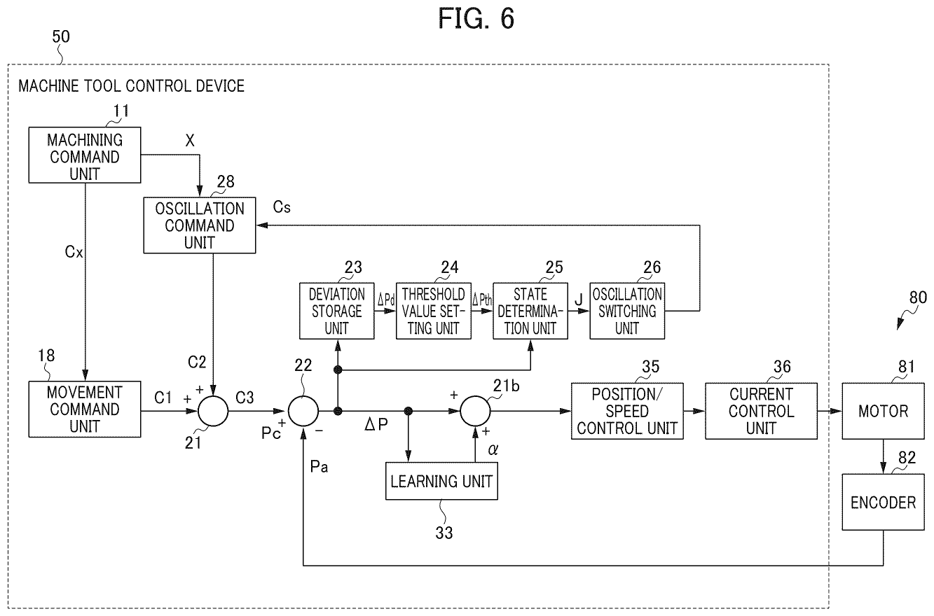

Next, the third embodiment will be described with reference to FIG. 6. The present embodiment is described with a focus on the differences from the second embodiment, and the same or similar aspects to the second embodiment will be omitted as appropriate.

The machine tool control device 50 further includes a learning unit 33 and a second adder 21b. The learning unit 33 calculates a correction amount α based on the position deviation ΔP, and reduces the position deviation ΔP by adding the calculated correction amount α to the position deviation ΔP using the second adder 21b. The learning unit 33 includes a memory and stores the oscillation phase and the position deviation ΔP in the memory in association with each other, within one or more oscillation cycles. The learning unit 33 outputs the correction amount α, calculated based on the position deviation ΔP stored in the memory, to the second adder 21b at a timing that can compensate for the phase lag of the oscillation operation in accordance with the response characteristics of the motor 81. In general, as the oscillation frequency increases, the position deviation ΔP relative to the command amplitude becomes larger. Therefore, the followability of the actual relative oscillation to the cyclic oscillation command C2 can be improved through correction using this learning unit 33. As a result, the followability of the actual relative position Pa to the command relative position Pc is also improved, thereby reducing the position deviation ΔP. Consequently, machining accuracy can be improved.

As described above, the learning unit 33 calculates the correction amount α based on the position deviation ΔP, and corrects the position deviation ΔP by adding the calculated correction amount α to the position deviation ΔP. This reduces the position deviation ΔP. The oscillation conditions are changed, on condition that the position deviation ΔP exceeds the threshold value ΔPth. Therefore, the frequency of changes in the oscillation conditions is expected to be suppressed, and mechanical resonance is expected to be further suppressed.

### OTHER EMBODIMENTS

The embodiments described above can be modified as follows, for example. As the switching processing, the oscillation switching unit 26 may performs a process of notifying the user, through at least one of displaying or emitting a sound, that the oscillation conditions need to be changed, instead of a process of changing the oscillation conditions. Specifically, for example, as the switching processing, the display may provide the displaying. Alternatively, the oscillation switching unit 26 may include a speaker, and the speaker may emit the sound as the switching processing.
22: subtractor (position information acquisition unit)
23: deviation storage unit
24: threshold value setting unit
25: state determination unit
26: oscillation switching unit
33: learning unit
50: machine tool control device
80: machine tool
86: workpiece
88: cutting tool
C1: movement command
C2: oscillation command
C3: superimposed command
Cp: computer
Pa: actual relative position
Pc: command relative position
Pg: machine tool control program
ΔP: position deviation
ΔPth: threshold value
ΔPmax: sectional maximum deviation
ΔPmax_min: minimum value of sectional maximum deviation
ω: oscillation cycle

1. A machine tool control device that controls a machine tool including a cutting tool for cutting a workpiece, and superimposes an oscillation command instructing relative oscillation between the workpiece and the cutting tool onto a movement command instructing relative movement between the workpiece and the cutting tool, thereby generating air cuts to break up chips while cutting the workpiece, the machine tool control device comprising:
a position information acquisition unit that acquires position information on a relative position between the workpiece and the cutting tool;
a state determination unit that determines an unstable state, on condition that a position deviation exceeds a threshold value, wherein the position deviation increases as a difference between an actual relative position as the relative position based on the position information and a command relative position as the relative position based on the movement command and the oscillation command increases; and
an oscillation switching unit that executes switching processing for changing an oscillation condition of the relative oscillation, on condition that the unstable state has been determined.

2. The machine tool control device according to claim 1, wherein the oscillation switching unit executes at least one of processing for changing a frequency of the relative oscillation or processing for reducing an amplitude of the relative oscillation based on the oscillation command, as the switching processing.

3. The machine tool control device according to claim 1, wherein the oscillation switching unit executes processing for notifying a user, through at least one of displaying or emitting a sound, that the oscillation condition needs to be changed, as the switching processing.

4. The machine tool control device according to claim 1, further comprising a threshold value setting unit that sets the threshold value to a value greater than the amplitude of the relative oscillation based on the oscillation command.

5. The machine tool control device according to claim 1, further comprising: a deviation storage unit that stores the position deviation; and a threshold value setting unit that sets the threshold value based on history of the position deviation stored in the deviation storage unit.

6. The machine tool control device according to claim 5, wherein the threshold value setting unit calculates a sectional maximum deviation as a maximum value of the position deviation or a maximum absolute value of the position deviation for each divided section divided based on an oscillation cycle as a cycle of the relative oscillation, and determines the threshold value, based on the sectional maximum deviation.

7. The machine tool control device according to claim 6, wherein a length of each divided section is an integral multiple of half a length of the oscillation cycle.

8. The machine tool control device according to claim 6, wherein the threshold value setting unit sets the threshold value to a value obtained by multiplying the sectional maximum deviation for the divided section where the sectional maximum deviation becomes minimum, or an average value of the sectional maximum deviation for a plurality of the divided section, by a predetermined multiplying factor greater than 1.

9. The machine tool control device according to claim 1, further comprising a learning unit that calculates a correction amount of the position deviation, based on the position deviation, and corrects the position deviation by adding the calculated correction amount to the position deviation.

10. A non-transitory computer-readable storage medium storing a machine tool control program that causes a computer to function as a machine tool control device that controls a machine tool including a cutting tool for cutting a workpiece, and superimposes an oscillation command instructing relative oscillation between the workpiece and the cutting tool onto a movement command instructing relative movement between the workpiece and the cutting tool, thereby generating air cuts to break up chips while cutting the workpiece,
the machine tool control program further causing the computer to function as units comprising:
a position information acquisition unit that acquires position information on a relative position between the workpiece and the cutting tool;
a state determination unit that determines an unstable state, on condition that a position deviation exceeds a threshold value, wherein the position deviation increases as a difference between an actual relative position as the relative position based on the position information and a command relative position as the relative position based on the movement command and the oscillation command increases; and
an oscillation switching unit that executes switching processing for changing an oscillation condition of the relative oscillation, on condition that the unstable state has been determined.
